(19) United States
(12) Patent Application Publication
(10) Pub. No.: US 2006/0271458 A1
(43) Pub. Date: Nov. 30, 2006

(54) Method for financing real estate purchases

(75) Inventors: Charles O. Arnold III, Denver, CO (US); Michael E. Doty, Thornton, CO (US)

Correspondence Address: Stephen B. Perkins, Esq.;Greenberg Traurig, LLP, Suite 2400, 1200 Seventeenth Street, Denver, CO, 80202, US

(73) Assignee: Shared Equity Financing, LLC

(21) Appl. No.: 11/139,393

(22) Filed: May 27, 2005

(51) Int. Cl. G06Q 40/00

(52) U.S. Cl. 705/35; 705/40

(57) ABSTRACT

A method for financing real estate purchases using a shared equity model is disclosed. In the disclosed method, the land portion of the real estate is financed using a land lease agreement, while the improvements to the land (e.g., a house) are purchased under a typical mortgage scenario. The land lease agreement provides for a required minimum annual return on investment to the land equity investor over a predetermined term. The borrower must pay an additional required minimum monthly payment, which may be made to the lender to pay down the mortgage, in addition to the payment required under the mortgage such that the additional required minimum monthly payment is sufficient to meet the required minimum annual return specified in the land lease agreement. Finally, the borrower may defer lease payments to the equity investor, and pay them at some date in the future.

### BACKGROUND OF THE INVENTION

1. Field of the Invention

This invention relates to a method for financing real estate purchases using a shared equity model.

2. Description of the Relevant Art

Methods for purchasing real estate have existed for hundreds of years, from the earliest days of simple barter and exchange, to the sophisticated mortgage financing available today. For many years, lenders have competed by developing methods for structuring mortgages, which provide for both convenience and financial benefit to the borrower while addressing issues of risk to the lender.

A relatively new concept for real estate purchase splits the land estate from the improvements, and permits the borrower to obtain a mortgage on only improvement portion of the estate. A third party owns title to land estate for the exclusive benefit and use of the borrower. The following sections describe the types of real estate purchase structures heretofore known in the prior art.

Residential Land (Ground) Leases

Land leases (or ground leases) are a type of real estate transaction wherein the owner of undeveloped, or partially developed (utility infrastructure) land leases the property under (usually) a long term lease. The lessee is permitted to develop and/or use the land, but any improvements on the property (for example, a house or an apartment building) usually revert back to the land owner at the end of the lease period, usually without additional compensation or payment. Thus, as the end of the lease term gets nearer and nearer, the house, for example, has less and less remaining value because any potential buyer would only have only a limited span of usage.

Land leases are most often used in commercial real estate transactions. However, residential land leases do exist with individual single family homes in limited geographical regions of this country. The majority of residential land leases are found in planned housing communities, reservation lands held by Native Americans, or public sponsored development projects established to created a community land trust (“CLT”).

Land Leased Communities

Developers of residential land lease communities own home sites that are leased to homeowners in the community. The homeowner typically purchases a home, which is then placed on the leased property. At the expiration of the lease, the lease is renewed or the home is removed from the site. In some cases the home and land revert to the land lessor.

There are a relatively large number of land leased communities in the United States. Most are limited to manufactured housing and emphasized the affordability of a land leased manufactured home over more traditional stick-built housing. For example, American Land Lease, a real estate investment trust (REIT), develops heavily ammenitized, maintenance free lifestyle communities directed toward retirement age residents. American Land Lease's stated business is land development and new home sales, with a primary business objective of owning land leased to others.

The benefit of the residential land lease, from the perspective of the homeowner, is that it negates the need to spend capital on the purchase of the land. The homeowner, as a result of not owning the land, spends money only on the purchase or construction of the house. This significantly reduces the cost of home ownership to the homeowner.

Reservation Lands:

Reservations for Native Americans provide housing opportunities for tribal members, usually under a long term land lease where the land is held by the community and the home is individually owned. Financing is often provided under some form of government assistance program.

Reservation lands, like residential land leases, permit the homeowner to spend significantly less money on the purchase of the residence.

Community Land Trusts:

A community land trust (CLT) is a private, non-profit corporation created to acquire and hold land for the benefit of a community and provide secure affordable access to land and housing for community residents. CLTs were conceived in the 1960's in an effort to control land for the public good under long term land leases. They have gained in popularity since the 1980's as a means of providing low income housing and, in rural areas, protecting family farms.

CLTs attempt to meet the needs of residents least served by the prevailing market. CLTs prohibit speculation and absentee ownership of land and housing, promote ecologically sound land-use practices, and preserve the long-term affordability of housing.

Under a CLT model, the CLT continues to own the land while conveying the long-term use of the land to individuals, cooperatives or other entities. Leaseholders own their homes and other improvements. Terms of the arrangement between a CLT and an owner using the land are defined in a long-term lease. The land trust offers leaseholders security, an opportunity to transfer the lease to their heirs, and full rights of privacy.

A CLT maintains control over the sale of buildings and other improvements on its land. In particular, the CLT retains an option to repurchase these improvements at a limited price if residents choose to sell. The CLT lease agreement typically includes a formula for calculating this price that offers resident-owners fair compensation for their investment, which usually reflects only a small portion of the market appreciation of the property.

While CLTs are an excellent model for maintaining affordability of housing for lower income purchasers, they do not permit a homeowner to realize the true potential of the home investment due to restrictions on sale of a CLT home. Without unrestricted transfer of title and ownership of the land, the homeowner cannot realize the full appreciation in property value at the time a home is sold or refinanced.

Residential Leasehold Mortgage Financing:

A leasehold mortgage is a mortgage collateralized by the tenant's leasehold interest and interest in title (usually structural improvements) in a leased parcel of property. Usually, a leasehold mortgage is subordinate to the landlord's land lease since it is a second lien by order of priority on the property. The leasehold interest is created when the landlord (a fee simple landowner) enters into an agreement or contract called a ground lease with a lessee. The lessee buys leasehold rights much as one buys fee simple rights; however, the leasehold interest differs from the fee simple interest in several important respects. First, the buyer of residential leasehold property does not own the land and must pay ground rent. Second, his use of the land is limited to the remaining years covered by the lease. Therefore, the use of the land returns to the lessor, and is called reversion. Depending on the provisions of the surrender clause in the lease, the buildings and other improvements on the land may also revert to the lessor. Finally, the use, maintenance, and alteration of the leased premises are subject to any restrictions contained in the lease.

Historically, most residential leasehold mortgages have been chattel mortgages used to finance manufactured homes. However, recent trends in the manufactured housing industry have resulted in a growing number of homes designed and built for permanent building foundations, thereby qualifying for traditional real property mortgage financing. In response to changing market conditions, Freddie Mac has developed a sample “Residential Ground Lease Agreement” incorporating its ground lease requirements to reflect the market for mortgages secured by leasehold estates in ground or land lease communities where manufactured homes qualify as real property.

Shared Equity Financing:

Shared Equity/Shared Capital Gain Financing:

In Australia, Midware Ltd. launched a shared equity finance, or what they refer to as “shared capital gain” concept in 2003. Recently revised and called a “Lifestyle Loan,” this program provides for a third party equity “investor” who contributes funds toward the home purchase to reduce the amount of required conventional financing. In exchange for this capital investment, the investor shares in the homeowner's capital gain (property appreciation) based on a predetermined split, usually 30% to 50% going to the investor.

Capital gain is based on average price increases for the neighborhood. The investor does not share in the homeowner's equity; the reduction in loan balance, plus any additional capital investment made on behalf of the homeowner for home improvements. Investors in this program are expected to be “industry super funds” or credit unions.

Shared Appreciation Financing:

Shared appreciation financing refers to a financing model in which the Lender receives a share of the future property appreciation in exchange for a below market interest rate. Alternatively, the homebuyers can elect to reduce the initial purchase price on the home they are purchasing in return for sharing with the builder the appreciation when the house is resold.

When discounting the price, for every 1% discount received, the builder receives a 5% share of any appreciation. The maximum discount in the price the purchaser may receive is 10%. Upon the sale of the house, all proceeds up to the original discount price go to the purchaser. Proceeds from the discounted price up to the original list price will go to the builder. Above the original list price, all proceeds will be divided. The builder will receive between 5% and 50% of the excess over the original list price, depending on the amount of the original discount.

In the event that the new sales price is less than the original discounted price, the builder receives nothing. If the selling price is more than the initial discounted sales price, but less than the initial list price, the builder will only be entitled to the excess over the initial discounted price. The builder has the right of first refusal at the time of the resale.

Five years after the closing, the Purchaser will have the opportunity to buy out of this program by paying the builder the original discounted amount together with interest at an annual rate of 9.5% compounded annually. For example, if the initial list price of the home is $300,000 and the purchaser receives a 10% discount, the price of the home would be $270,000. Shown here are four possible scenarios.

(A) The house resells for $340,000. $30,000 (the difference between the list price and the discounted price) goes to the builder. For the $40,000 profit above the $300,000, 50% or $20,000 will go to the builder. The builder's share will be $50,000 ($30,000+$20,000). The purchaser's share will be $290,000 ($270,000+$20,000).

(B) The house resells for $290,000. The builder will receive $20,000 and the purchaser will receive $270,000.

(C) The house resells for $265,000. The builder will receive nothing, and the purchaser will receive $265,000.

(D) The buyer elects the buy-out option at the end of the fifth year. The amount owed to the builder by the purchaser will be $47,227.16 ($30,000+$17,227.16 interest at 9.5% compounded annually).

Shared Equity Financing/Joint Ownership Agreements:

Several references were found to a program identified as “Shared Equity Financing” (sometimes referred to as a “Joint Ownership Agreement”). This structure—marketed primarily toward parents looking for ways to assist their children with the purchase, of a first home—looks like a version of the Australian “Lifestyle Loan” model previously described, with one key distinguishing factor; the investor in this case takes an ownership interest in the home purchase, rather than just a lending position.

In this structure the investor provides the required down payment and signs on the mortgage note for an undivided interest in the property, say 50%. The homeowner or occupant signs the mortgage note for the remaining 50% interest. The investor and the homeowner/occupant then enter into a written “shared equity financing agreement” (“SEFA”), as provided for under IRS code. The homeowner/occupant, or tenant, pays rent to the investor for its 50% interest in the property, in an amount not less than 80% of market rent. The investor treats this income as rental income and is allowed to recognize all customary landlord expenses, including depreciation. There can be no requirement for sale under the SEFA. However, both parties to the agreement can mutually agree to sell at any time. At the time of sale the investor's interest qualifies for a like-kind exchange for purposes of a section 1031 exchange.

One observation worth noting with respect to this shared equity program is that if the IRS were to treat the structure as equity sharing under its SEFA regulations, the homeowner risks losing a portion of the deduction for interest and real estate taxes if it is determined that fair market rent is not paid to the investor. In this case the IRS would consider a portion of the homeowner's monthly mortgage payment as rent. The investor, therefore, would be required to recognize income it never received, and without the ability to off-set with deductions for real estate taxes and mortgage interest, since those expense are being paid for by the homeowner through monthly mortgage payments.

Payments identified as “additional payments” under our SEM are sufficient to not only meet the necessary return requirements of the land investor, but we believe avoid the imputed rent issue as discussed above, and at a substantially lower cost to the homeowner given the benefit of a monthly accrual structure where payments are applied against mortgage principal during the homeowner's period of ownership.

Halal Financing (Lease-To Purchase Financing):

Muslims are prohibited under the Qur'an from paying interest in financial transactions, on both sides of the transaction, making it difficult to work with traditional mortgage financing programs. In response to this dilemma a group of Canadian Muslims introduced “Halal financing”

Halal financing allows an individual to purchase a home with one or more investors, occupy the house as a renter and then buy back the investors property interest over time through a lease-to-purchase agreement. By renting at or above market value, the occupant can allocate a percentage of the rent payment toward purchase of the investor's property interest. Rents are adjusted annually to reflect market conditions. Property taxes, insurance and maintenance are considered the investor's expenses, while lawn care, snow removal and utilities are expenses paid by the tenant-purchaser.

While the foregoing real estate purchase structures have proven to provide greater convenience to the buyer and more security to the lender, the borrower typically does not acquire title to the entire estate. Therefore, she cannot realize the true potential of the real estate investment. The SEM structure hereafter disclosed addresses the problems inherent in the foregoing structures.

### SUMMARY OF THE INVENTION

A method for structuring a three-party real estate transaction using a shared equity model is disclosed. Under this model, at the time a home is purchased, a land equity investor, purchases the land, for cash, and holds title to the land for the exclusive use and benefit of the homeowner during the homeowner's period of ownership, or until such time as the homeowner may elect to purchase the land and merge the two estates. The homeowner leases the land under a land lease agreement with the land equity investor, which provides the land equity investor with a minimum required rate of return on it's investment at the time the homeowner elects to sell or refinance, plus a share of any appreciation. The homeowner then secures traditional mortgage financing for only the cost of improvements to the land (e.g., a house) from a traditional mortgage lender.

Instead of paying lease payments to the land equity investor, the borrower instead pays the mortgage lender a specified monthly amount in addition to the monthly mortgage payment. This fixed amount is calculated at the time the mortgage is put in place to accelerate the amortized principal under the mortgage sufficient to meet the land equity investor's minimum required rate of return specified in the land lease agreement over a projected period of homeownership and to satisfy the lender's risk requirement. This extra payment is applied to mortgage principal thus resulting in acceleration of the amortization of the mortgage, and an increase in the borrower's equity in the improvements. When this increased equity is realized by the homeowner (e.g., by sale of the home or refinancing), the equity investor's initial land investment is paid first, with the balance going to the homeowner.

It is an object of the present invention to deliver a viable real estate financing structure that significantly reduces the homeowner's monthly mortgage cost.

It is a further object of the present invention to deliver a viable real estate financing structure that significantly reduces the homeowner's monthly mortgage cost without increasing lender risk.

It is a still further object of the present invention to deliver a viable real estate financing structure that provides a long-term, low-risk, fixed income opportunity for investing in the real estate market.

### DESCRIPTION OF THE PREFERRED EMBODIMENT

There are three parties to the invention, or shared equity model (SEM) structure; a traditional mortgage lender, a borrower (e.g., a homeowner), and a land equity investor. Under the disclosed method, the borrower enters into separate agreement with the land equity investor for the use of the land and the mortgage lender to finance the purchase of the improvements to the land. These agreements may be structured to provide significant advantages to all three parties, which are not possible using the prior art methods of financing real estate purchases.

For purposes of establishing each party's financial contribution toward the real estate purchase, the market value of each of the land and the improvements to the land, may be estimated by using the county assessor's most recent valuation for each component (land and improvements) expressed as a percentage of the total “actual” or “market” property value. This percentage is then applied to the purchase price set forth in the buyer's and seller's purchase and sale agreement to arrive at an estimated land and improvement value. Prior to loan funding and closing, market value may be confirmed by a third party appraisal, as is currently the practice in traditional residential home financing.

Mortgage Lender

The mortgage component of the SEM structure operates similarly to traditional mortgage financing, except that the total amount of the mortgage does not include the value of the land estate. Under the SEM structure, the borrower finances only the cost of the improvements to the land, resulting in a mortgage amount that is significantly smaller than one incorporating both the land estate and the improvements. This mortgage is similar in all respects to a traditional mortgage, and may be structured in any manner known in the art.

Typically, the mortgage will be some form of a standard 15 year or 30 year fixed or adjustable mortgage. However, any form of mortgage financing suitable for purchasing real estate, whether traditional or non-traditional, may be used. Regardless of the financing method used for the mortgage, the borrower will pay a monthly amount during the mortgage term, which is specified under the mortgage contract. This payment is hereinafter referred to as the “mortgage payment.”

Land Equity Investor

In addition to the mortgage securing the improvements on the property, the SEM structure pairs a land equity investor with the borrower at the time of the real estate purchase. This land equity investor purchases the land component of the real estate for cash, and holds title to the land under a defeasible fee simple interest for the exclusive use and benefit of the borrower during the borrower's period of ownership, or until such time as the borrower elects to purchase the land estate from the land equity investor and merge the two estates.

At the time of the transaction closing the borrower and the land equity investor execute a land lease agreement. Preferably, this land lease agreement is structured to provide for an absolute net lease, bond-like investment for the land equity investor. Property taxes and insurance, for both the land and improvements, are preferably escrowed from the homeowner's monthly mortgage payments and paid by the lender as is the practice with a traditional home mortgage.

Land Lease Payments/Return on Investment

The land equity investor is the lynchpin in the SEM structure. In order to attract investors to become land equity investors, the land lease agreement must provide a low-risk investment, with an adequate minimum annual return. To this end, the land lease agreement will preferably include a yield requirement that sets a required minimum annual return for its investment to be achieved over a projected term, or hold period. This required minimum annual return should be sufficient to attract investment from the capital market. For example, the projected hold period might be set at approximately five (5) years to correspond with the current average length of homeownership based on published industry statistics, or some other relevant market statistic. Additionally, the required minimum annual return may be calculated to emulate a fair market return based on investments of risks similar or equivalent to the risks involved with the SEM structure.

The required minimum annual return may be embodied in the borrower's accelerated equity as a result of required additional monthly payments (“additional payments”), as required under the land lease agreement. These payments are similar to the monthly mortgage payment in the standard mortgage agreement, except that they reflect a payment only for the use of the land, not an ownership interest. The amount of the monthly land lease payment is calculated to be sufficient to meet the projected return requirement.

Instead of making the additional payments to the land equity investor, the borrower may make this payment to the mortgage lender, as an additional amount in excess of the borrower's monthly mortgage payment. The additional payments will be applied against the principal balance of the mortgage loan, and as a result, amortization under the mortgage is accelerated creating the potential for significant growth in borrower's equity during the period of ownership and reduce lender risk.

The additional payments in the SEM structure are important for three primary reasons. First, as set forth above, they provide for a minimum return to the land equity investor in the event the borrower elects to sell in a relatively short period of time and there is a minimal amount of appreciation in land value to provide a return to the land equity investor, or there simply has been no appreciation in property values. Second, they provide for a financial off-set to the land equity investor in cases where both estates share in appreciation disproportionately to what occurs in their respective estates and where land has appreciated at a significantly greater rate than what is recognized by the land equity investor. Finally, they provide for an acceleration in loan pay-off to reduce lender risk.

Failure to make the required payment would constitute a monetary default under the existing mortgage.

Realization of the value of the lease payments by the land equity investor is preferably deferred until some point in the future. For example, the lease payments may be deferred until such time as the borrower realizes his accelerated equity in the property through transfer of the real estate (e.g., subsequent sale), refinance, retirement of the purchase mortgage, or foreclosure. At the time this equity is realized, it is first distributed to the land investment fund in an amount sufficient to meet the established return requirement, with the remaining balance going to the homeowner.

Benefits to the SEM Parties

Homeowner/Borrower Benefits:

The SEM structure provides the borrower with lower mortgage payments. By removing the cost of land from the borrower's mortgage obligation, the borrower's required equity down payment for financing the real estate purchase may be reduced. Monthly mortgage payments are lowered, even with the required additional payments (land lease payments) necessary to service the land investment fund. In addition, higher interest rate mortgage debt is replaced with lower cost bond-like financing under the SEM structure.

The SEM structure provides the borrower no interest rate risk. The borrower has the opportunity under the SEM structure to substitute a fixed-rate, fully amortizing mortgage for an interest only, variable rate mortgage without incurring the full monthly mortgage expense associated with traditional fix-rate financing. In other words, the borrower can achieve close to, or lower than the same low monthly payment benefit associated with variable rate or interest only programs, but without incurring interest rate risk, and with the opportunity to realize some equity in the property.

The SEM structure provides the borrower a lower mortgage interest rate. The acceleration in amortization, as a result of the required additional payments, may allow for a lower mortgage interest rate, as a 30 year fully amortizing loan is likely to pay-off in less than 20 years and in some cases near 15 years, further enhancing the benefits of the SEM structure to both borrower and lender.

The SEM structure may provide the borrower with tax deductible lease payments. Under the SEM structure, lease payment(s) to the land equity investor may meet the five requirements under the Internal Revenue Service code to be considered “redeemable ground rent,” and as such may qualify as a deductible mortgage interest expense for the borrower in the year the expense is incurred (i.e. at the end of the holding period).

The SEM structure provides the borrower with increase security. The borrower preferably has the right, but not the obligation, during the term of the mortgage to acquire the land estate for its then current market value, plus that portion of the homeowner's equity necessary to meet the land investment fund's return requirement. Therefore, the borrower has the opportunity to merge the land estate with the improvement estate and obtain full ownership of the property at any time.

The SEM structure preferably provides the borrower with an assumable land lease. The land lease may be assumable by a subsequent purchaser, with distribution of equity to the land investment fund, as previously described. In such an event the then current market value for the land may be re-established, a new minimum return requirement may be set, and the land lease term may be extended beyond the mortgage term to meet the requirements of the mortgage lender and secondary market.

Lender Benefits

The SEM structure provides the lender with a model that may be acceptable in the secondary market. We anticipate the ability to draft the land lease agreement in a manner that complies with the 23 ground lease requirements established by Fannie Mae under Form 4326, and those requirements as provided for under the recently revised, and suggested, Freddie Mac Form Residential Ground Lease Agreement, making any currently accepted mortgage financing product saleable in the secondary market when applied to the purchase of home improvements under the SEM structure.

The SEM structure provides the lender with sufficient recourse. The mortgage lender has full recourse to the borrower's equity, including any portion which may occur as a result of the additional payments required under the land lease agreement. For instance, a portion of the total required minimum monthly payment might be determined according to the lender's risk requirements, and would offset such requirements. In most cases the accelerated equity build-up that occurs as a result of the required additional payments will be sufficient to give the lender a debt coverage ratio equal to or better under the SEM structure than what would be available under a traditional 30 year mortgage secured by both land and improvements, even after taking into consideration the costs associate with acquiring title to the land.

The SEM structure provides the lender the right to merge estates. In the event of foreclosure the lender preferably assumes the borrower's right to acquire title to the land, but has no obligation to merge the two estates.

The SEM structure provides the lender an assumable land lease agreement. A subsequent purchaser under a foreclosure may have the option to: 1) assume the ground lease for a new lease term with adjustments to the required additional payments as necessary in order to meet the current requirements of the land investment fund or 2) merge the two estates under a traditional mortgage structure, whereby the land investment fund is paid it's principal investment, plus any portion of the remaining equity in the property not required to satisfy the mortgage lender, and up to that amount necessary to meet the required return.

The SEM structure provides the lender no subordination. Disbursement of required lease payments to the land equity investor, in all cases, does not occur until after the mortgage obligation has been satisfied, thereby eliminating the lender's concern that its mortgage security (i.e., the improvements) might be at risk in the event there is a monetary default under the land lease agreement and a foreclosure action is initiated.

The SEM structure provides the lender reduced underwriting risk. The SEM structure reduces lender risk by 1) reducing monthly mortgage payments for the borrower making it easier to underwrite income requirements for marginally qualified home buyers; and, 2) providing the opportunity for mortgage lenders to fund smaller home purchase loans with shorter maturities, which allows for the greater distribution of capital.

Land Equity Investor Benefits

Required returns are met through a sharing of borrower equity created by the additional required mortgage payments made on a monthly basis, a portion of which offset traditional land lease payments, and/or through appreciation of the property that might take place over the lease term, to which the land investment fund would be entitled to receive as a property owner. Requirements for the additional monthly payments in order to meet investment yield expectations may relax over time as investors: 1) become more comfortable with the SEM structure and gain comfort in the prospects for significant appreciation in land value over the holding period (It has been estimated that over the past 50 years housing has appreciated an average of 5% per year), and 2) strive to enhance financial benefit to the borrower in an effort to insure the long-term viability of the program, where the land investor benefits every time a property is sold and refinanced through the SEM structure. Should this occur the benefits of the SEM structure would be further enhanced as the cost of capital to fund land acquisitions is reduced through investor speculation in the capital markets

The SEM structure provides the land equity investor with secured equity in two ways. First, there is no lender or borrower recourse to the land without full compensation to the land equity investor for its principal investment. The fund is at risk of loss only as to its return on investment, and not its invested capital. Second, appreciation in property values over relatively long periods of time occurs through appreciation in land values, as improvements tend to depreciate over time without significant contributions of additional capital.

The SEM structure provides the land equity investor with recourse to the improvements. In the event of a monetary default by the borrower under the land lease agreement, the land equity investor has full recourse to the improvements up to the current market value of its land investment, but no less than its original investment. In addition, in the event of a lender initiated foreclosure under a monetary default, the land equity investor will have recourse to the improvements, subordinate only to the mortgage lender.

Should the borrower's mortgage go to term, the borrower has the obligation to acquire the land estate prior to the expiration of the lease term. This obligation can be met through traditional mortgage refinancing, or as an alternative provision, the amount owed the land investment fund becomes the homeowner's new mortgage balance under a purchase money mortgage with terms that reflect then current market conditions.

Land in most cases represents 20 to 30 percent, or more, of the cost of real estate ownership, and is a growing concern to purchasers interested in living in urban neighborhoods where land costs are highest. We see the SEM structure as an opportunity to create more affordable housing opportunities for all buyers, but particularly for low to moderate income families and first-time home buyers who desire to relocate close to established urban employment centers, and for families who struggle to retain family homeownership in their historic city neighborhoods where opportunities for redevelopment reflect rapidly appreciating land values.

The SEM structure has been adapted to provide application to the investment real estate market to allow for the pairing of low risk, passive, and non-tax paying investors with higher risk investors who require more immediate investment returns and who stand to benefit from the tax benefits associated with ownership and the financing of real estate improvements, namely mortgage interest and depreciation.

While the method has been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method for structuring real estate purchases using a shared equity model comprising the steps of:
financing a borrower's purchase of improvements to a land portion of the estate pursuant to a mortgage between the borrower and a lender; and
financing the borrower's use of the land portion of the estate under a land lease agreement between the borrower and a land equity investor, whereby the terms of the land lease agreement provide for:
a minimum return on investment to the land equity investor over a predetermined term; and
a minimum monthly payment in addition to any mortgage payment.

2. The method of claim 1 wherein the terms of the land lease agreement further provide for deferred lease payments by the borrower to the land equity investor.

3. The method of claim 1 wherein the minimum monthly payment is made by the borrower to the lender to pay down the principal of the mortgage.

4. The method of claim 3 wherein at least a portion of the minimum monthly payment is calculated to offset the lender's risk.

5. The method of claim 1 wherein the minimum monthly payment is calculated so as to provide the required minimum return on investment to the land equity investor.

6. The method of claim 1 wherein the required minimum return on investment is calculated so as to emulate a fair market return based on investments of similar risks.

7. The method of claim 1 wherein the terms of the land lease agreement further provide that the borrower and the land equity investor share in any appreciation of the value of the land estate.
